(19) United States
(12) Patent Application Publication
(10) Pub. No.: US 2026/0276373 A1
(43) Pub. Date: Sep. 17, 2026

(54) OPTICAL LEVER DETECTION DEVICE FOR MICRO LED CHIP AND OPTICAL LEVER DETECTION THEREOF

(71) Applicant: FOSHAN UNIVERSITY, FOSHAN (CN)

(72) Inventors: JIAN QIAO, FOSHAN (CN); JUNJIE LI, FOSHAN (CN); ZHE JIN, FOSHAN (CN); JINGWEI YANG, FOSHAN (CN); YANLONG WU, FOSHAN (CN); JIHENG WANG, FOSHAN (CN); ZHENDUO WU, FOSHAN (CN); CHI SONG, FOSHAN (CN)

(21) Appl. No.: 19/568,716

(22) Filed: Mar. 16, 2026

(30) Foreign Application Priority Data
Mar. 17, 2025 (CN) 202510309041.7

(51) Int. Cl. G01B 11/26

(52) U.S. Cl. CPC G01B 11/26

(57) ABSTRACT

An optical lever detection device for a micro LED chip and an optical lever detection thereof are provided. The optical lever detection device includes a sample conveying stage, a force-sensing deformable piece, an optical module, and a detection module. The sample conveying stage is configured to carry a chip to be detected and convey the chip to be detected to a target detection position. The force-sensing deformable piece includes a clamping portion, a cantilever, and a probe. The optical module includes a support member, a clamp, a reflecting prism, a diaphragm assembly, and a laser source. The detection module includes a monitoring camera and a detector. A laser beam emitted by the laser source passes through the diaphragm assembly to the reflecting prism and is reflected by the reflecting prism to the probe. Angle information of reflected light on the probe is identified by the detector.

### TECHNICAL FIELD

The present disclosure relates to a technical field of chip bonding quality detection, and in particular to an optical lever detection device for a micro LED chip and an optical lever detection thereof.

### BACKGROUND

With innovative development of LED display technology, size specifications and pixel pitch of LED chips gradually advance toward the micro-nano scale, making large-format display panels flexible to assemble, interactive, and convenient for modular manufacturing. Panel-level micro LED displays, with advantages such as high brightness, high contrast, low power consumption, fast response time, and excellent color performance, have gradually become a primary development direction for a next generation of new display technologies.

In the prior art, Chinese patent No. CN115407181B discloses a non-destructive detection device for an LED chip. The non-destructive detection device comprises a power source, a conductive liquid discharge mechanism, and a detection mechanism. The conductive liquid discharge mechanism comprises a liquid pressure controller and a microfluidic chip. The liquid pressure controller and the power source are connected to the microfluidic chip. The microfluidic chip has rows of first guiding holes configured to guide a positive conductive liquid and rows of second guiding holes configured to guide a negative conductive liquid. The liquid pressure controller is communicated with one of the rows of the first guiding holes and one of the rows of the second guiding holes to control a circulation of the positive conductive liquid in the first guiding holes and a circulation of the negative conductive liquid in the second guiding holes. The detection mechanism comprises a support frame and an optical sensor. The support frame and the optical sensor are spaced apart from the microfluidic chip. The support frame defines a groove, the optical sensor is disposed within the groove, and a wafer loaded with LED chips is placed at an opening of the groove. In the non-destructive detection device, a probe is replaced with the conductive liquid discharge mechanism, thereby eliminating a need for probe replacement and improving detection efficiency of the non-destructive detection device to a certain extent.

Furthermore, the Chinese patent application No. CN116665567A discloses a detection method for a Mini or micro LED chip and system thereof. The detection method comprises collecting a first image set of a target display area of a chip under a first image driving signal; performing a first analysis on the first image set to obtain image quality information; performing a second analysis on the first image set to obtain a Mura compensation value; and completing optical correction based on the Mura compensation value. The first image driving signal comprises an automated optical inspection (AOI) driving signal for lighting detection after die bonding; and the first image set comprises brightness and chromaticity value information. The detection method and the system shorten a production process, reduce product convey, and save equipment and labor costs to a certain extent.

However, due to a reduction in size specifications of the micro LED chips, unstable solder bonding is likely to occur when transferring and soldering the micro LED chips onto a substrate, which affects a bonding force of a connection between the micro LED chips and the substrate, further leading to problems in micro LED display panels such as uneven brightness, color deviation, pixel failure, inconsistent response time, and unstable service life. These issues directly affect the display effect and quality of the large-format display panels and seriously hinder a commercial promotion process of the panel-level micro LED displays.

### SUMMARY

A first objective of the present disclosure is to provide an optical lever detection device for a micro LED chip, which aims to solve a problem of unstable bonding force for connection between the micro LED chip and a substrate.

To achieve the above objective, the present disclosure provides the optical lever detection device for the micro LED chip. The optical lever detection device comprises a sample conveying stage, a force-sensing deformable piece, an optical module, and a detection module. The sample conveying stage is configured to carry a chip to be detected and convey the chip to be detected to a target detection position. The force-sensing deformable piece comprises a clamping portion, a cantilever, and a probe. Two ends of the cantilever are respectively connected to the clamping portion and the probe. The probe abuts against the chip to be detected.

The optical module comprises a support member, a clamp, a reflecting prism, a diaphragm assembly, and a laser source. One end of the clamp connected to the support member is configured to connect the clamping portion. The reflecting prism is slidable on the support member and is disposed above the clamping portion. The laser source is disposed on one side of the support member away from the reflecting prism. The diaphragm assembly is disposed between the laser source and the reflecting prism. The detection module comprises a monitoring camera and a detector. The monitoring camera is disposed above the probe and is configured to identify a position of the force-sensing deformable piece with respect to the chip to be detected. The detector is disposed in an oblique upward direction of the probe.

A laser beam emitted by the laser source passes through the diaphragm assembly to the reflecting prism. The laser beam is reflected by the reflecting prism to a surface of the probe. Angle information of reflected light on the surface of the probe is identified by the detector. When a deformation amount of the probe on the chip to be detected changes, an angle of the reflected light on the surface of the probe changes, so as to detect a magnitude of a bonding force of the chip to be detected on a substrate.

Furthermore, a contact force between the probe and the chip to be detected is defined as F. A deflection angle between the cantilever and the clamping portion is defined as a. The deflection angle a is positively correlated with the contact force F.

Furthermore, a bonding force between the chip to be detected and the substrate is defined as f. A point where the laser beam hits the probe is defined as a spot. One side of the probe contacting the chip to be detected is defined as a contact surface. A horizontal distance from the spot to the contact surface is defined as l. A horizontal distance from the contact surface to the cantilever is defined as L. When 0 < F ≤ 1/2 f, l = 2/3 L. When 1/2 f < F ≤ f, l = 1/3 L.

Furthermore, the probe is inclined downward and is connected to one end of the cantilever. A deflection angle between the cantilever and the probe is defined as b. When 1/2f<F≤f, the deflection angle b is positively correlated with the bonding force f.

Furthermore, the support member comprises a limiting groove, a light guiding groove, and a notch. The limiting groove is disposed at one end of the support member. The light guiding groove communicates the laser source with the limiting groove. The reflecting prism is slidable on the limiting groove. The notch is disposed below and communicated with the limiting groove. The clamp fixes the clamping portion to one side of the limiting groove. The notch directly faces the probe. The laser beam emitted by the laser source respectively passes through the light guiding groove, the limiting groove, and the notch to the probe.

Furthermore, the optical module further comprises a first fastener and a second fastener. The first fastener is connected to the reflecting prism in a direction parallel to the light guiding groove, and the second fastener abuts against the reflecting prism in a direction perpendicular to the light guiding groove, so as to adjust a position of the reflecting prism with respect to the limiting groove.

Furthermore, the diaphragm assembly comprises a first diaphragm and a second diaphragm. The first diaphragm and the second diaphragm are spaced apart on the light guiding groove.

Furthermore, the optical lever detection device further comprises a digital terminal, and the digital terminal is electrically connected to the monitoring camera and the detector.

A second objective of the present disclosure is to provide an optical lever detection method for a micro LED chip, which aims to solve the problem of unstable bonding force for connection between the micro LED chip and a substrate.

To achieve the above objective, the present disclosure provides the optical lever detection method for the micro LED chip. The optical lever detection method is applied to the optical lever detection device described above and comprises steps:

S1: determining a bonding force between the chip to be detected and the substrate;

S2: mounting the chip to be detected on the sample conveying stage, and controlling the sample conveying stage to drive the chip to be detected to move to the target detection position to enable the probe to abut against the chip to be detected;

S3: continuing to drive, by the sample conveying stage, the chip to be detected to move toward the probe, so that the probe generates a pressing force forcing the force-sensing deformable piece to generate the deformation amount;

S4: detecting, by the detection module, the deformation amount of the force-sensing deformable piece and converting the deformation amount into an angular displacement of the laser beam; and

S5: transmitting, by the monitoring camera and the detector, the angular displacement of the laser beam to a digital terminal, converting, by the digital terminal, the angular displacement of the laser beam into an electrical signal, calculating a current contact force of the chip to be detected in real time, and when the current contact force reaches the bonding force for connection between the chip to be detected and the substrate, controlling the sample conveying stage to stop moving.

Furthermore, before the step of when the current contact force reaches the bonding force for the connection between the chip to be detected and the substrate, controlling the sample conveying stage to stop moving, the optical lever detection method further comprises:

controlling the reflecting prism to move away from the probe when the bonding force is much greater than the contact force; and

controlling the reflecting prism to move toward the probe when the bonding force is close to the contact force.

In the present disclosure, the laser beam emitted by the laser source passes through the diaphragm assembly to the reflecting prism. The laser beam is reflected by the reflecting prism onto the surface of the probe. The angle information of reflected light on the surface of the probe is received and identified by the detector. When a deformation amount of the probe on the chip to be detected changes, the cantilever or the probe deforms, and the angle of the reflected light on the surface changes. Then, the detector detects the magnitude of the bonding force of the chip to be detected on the substrate according to a change in the angle of the reflected light, so as to solve the problem of unstable bonding force for connection between the micro LED chip and the substrate in the prior art.

In the optical lever detection device for the micro LED chip of the embodiment, the support member comprises the limiting groove, the light guiding groove, and the notch. The limiting groove is disposed at one end of the support member, the light guiding groove communicates the laser source with the limiting groove, the reflecting prism is slidable on the limiting groove, the notch is disposed below and communicated with the limiting groove, the clamp fixes the clamping portion to one side of the limiting groove, and the notch directly faces the probe, so that by adjusting the position of the reflecting prism in the limiting groove, a position where the laser beam is reflected to the probe is forced to change, thereby causing the angle of the reflected light reflected by the probe to change according to the deformation amount of the cantilever or the probe.

In the optical lever detection method for the micro LED chip of the embodiment, the chip to be detected is mounted on the sample conveying stage, and the sample conveying stage drives the chip to be detected to move to the target detection position to enable the probe to abut against the chip to be detected. Then, the sample conveying stage continues to drive the chip to be detected to move toward the probe, so that a pressing force is generated between the probe and the chip to be detected, and the pressing force forces the force-sensing deformable piece to generate the deformation amount. The detection module detects the deformation amount of the force-sensing deformable piece and converts the deformation amount into the angular displacement of the laser beam. Finally, the monitoring camera and the detector transmit the angular displacement of the laser beam to the digital terminal, and the digital terminal converts the angular displacement of the laser beam into the electrical signal and calculates the contact force of the chip to be detected in real time. When the current contact force reaches the bonding force for connection between the chip and the substrate, the sample conveying stage is controlled to stop moving.

### BRIEF DESCRIPTION OF DRAWINGS

In order to clearly describe technical solutions in the embodiments of the present disclosure, the following will briefly introduce the drawings that need to be used in the description of the embodiments or the prior art. Apparently, the drawings in the following description are merely some of the embodiments of the present disclosure, and those skilled in the art are able to obtain other drawings according to the drawings without contributing any inventive labor.

FIG. 1 is a schematic diagram of an optical lever detection device for a micro LED chip according to one embodiment of the present disclosure.

FIG. 2 is a schematic diagram showing a principle of the optical lever detection device for the micro LED chip according to one embodiment of the present disclosure.

FIG. 3 is a schematic diagram of an optical module according to one embodiment of the present disclosure.

FIG. 4 is an exploded schematic diagram of the optical module according to one embodiment of the present disclosure.

FIG. 5 is a schematic diagram of a support member according to one embodiment of the present disclosure.

FIG. 6 is a schematic diagram of a force-sensing deformable piece according to one embodiment of the present disclosure.

FIG. 7 is an enlarged schematic diagram of portion A shown in FIG. 6.

FIG. 8 is a flowchart of an optical lever detection method for the micro LED chip according to one embodiment of the present disclosure.

In the drawings: 100-optical lever detection device; 110-sample conveying stage; 120-chip to be detected; 121-substrate; 130-force-sensing deformable piece; 131-clamping portion; 132-cantilever; 133-probe; 140-optical module; 141-support member; 1411-limiting groove; 1412-light guiding groove; 1413-notch; 142-clamp; 143-reflecting prism; 144-diaphragm assembly; 1441-first diaphragm; 1442-second diaphragm; 145-laser source; 146-first fastener; 147-second fastener; 150-detection module; 151-monitoring camera; 152-detector; 160-digital terminal.

### DETAILED DESCRIPTION

For ease of understanding the present disclosure, the present disclosure is described fully hereinafter with reference to the accompanying drawings. Several embodiments of the present disclosure are given in the accompanying drawings. However, the present disclosure may be implemented in many different forms and is not limited to the embodiments described herein. On the contrary, a purpose of providing these embodiments is to make the disclosure of the present disclosure more thorough and comprehensive.

It should be noted that when an element is referred to as being "fixed to" another element, it may be directly fixed to another element or indirectly fixed to another element through intervening elements. When the element is considered to be "connected" to another element, it may be directly connected to another element or intervening elements may be present at the same time. The terms "vertical", "horizontal", "left", "right", and the like, as used herein, are for illustrative purposes only.

Unless otherwise defined, all technical and scientific terms used herein have the same meaning as commonly understood by those skilled in the art of the present disclosure. The terms used in the specification of the present disclosure are only for the purpose of describing specific embodiments, and are not intended to limit the present disclosure. As used herein, the term "and/or" includes all combinations including one or more of the associated listed items.

### Embodiment 1

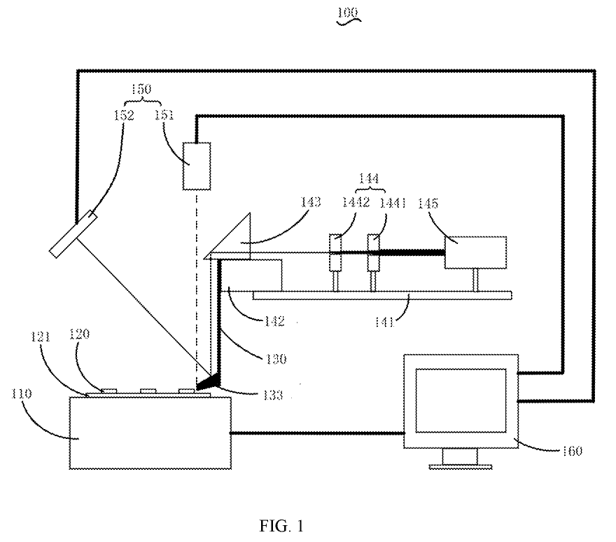

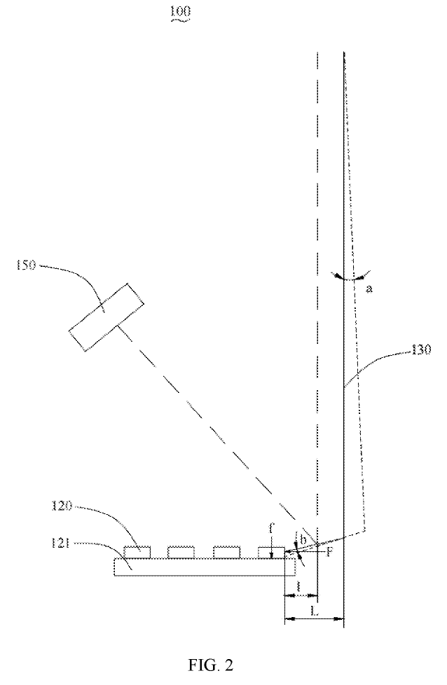

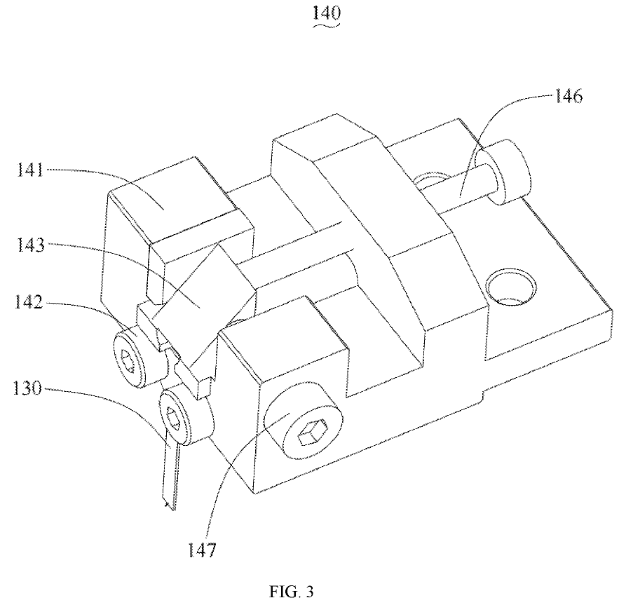

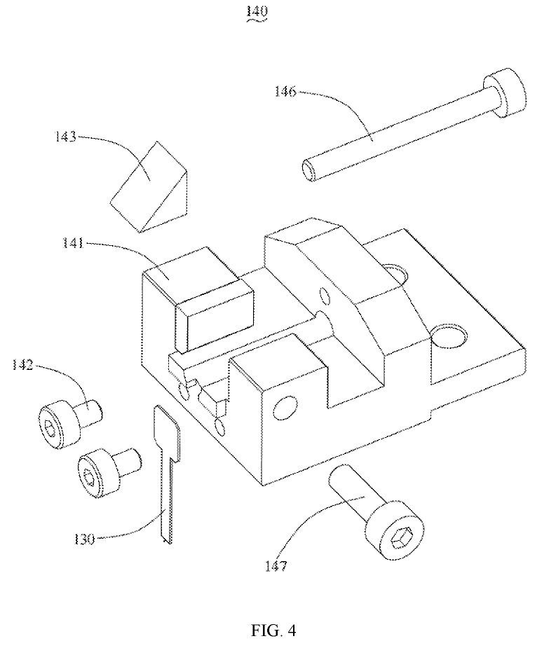

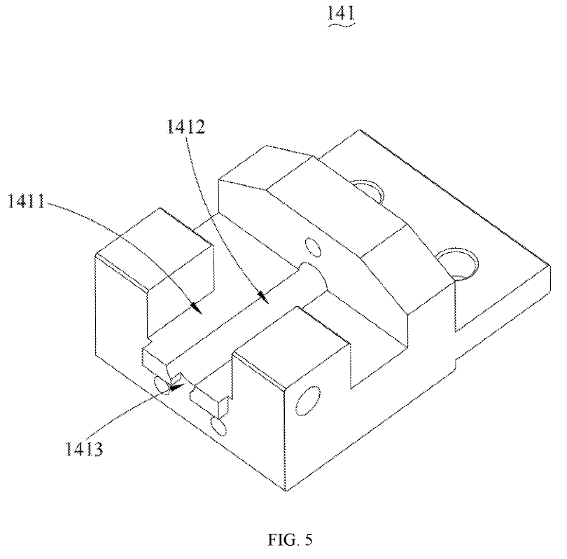

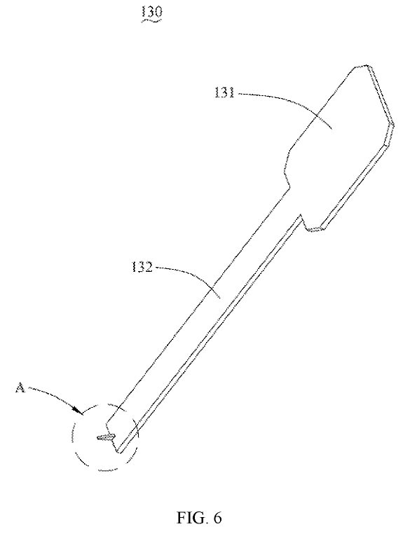

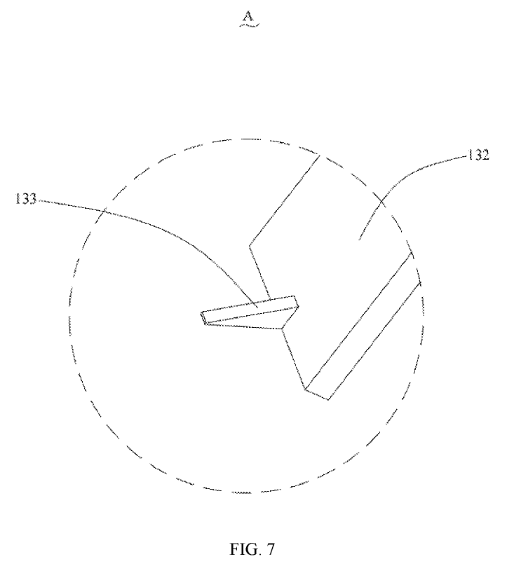

As shown in FIGS. 1-7, the embodiment of the present disclosure provides an optical lever detection device 100 for a micro LED chip. The optical lever detection device 100 comprises a sample conveying stage 110, a force-sensing deformable piece 130, an optical module 140, and a detection module 150. The sample conveying stage 110 is configured to carry a chip to be detected 120 and convey the chip to be detected 120 to a target detection position. The force-sensing deformable piece 130 comprises a clamping portion 131, a cantilever 132, and a probe 133. Two ends of the cantilever 132 are respectively connected to the clamping portion 131 and the probe 133. The probe 133 abuts against the chip to be detected 120.

The optical module 140 comprises a support member 141, a clamp 142, a reflecting prism 143, a diaphragm assembly 144, and a laser source 145. One end of the clamp 142 connected to the support member 141 is configured to connect the clamping portion 131. The reflecting prism 143 is slidable on the support member 141 and is disposed above the clamping portion 131. The laser source 145 is disposed on one side of the support member 141 away from the reflecting prism 143. The diaphragm assembly 144 is disposed between the laser source 145 and the reflecting prism 143.

The detection module 150 comprises a monitoring camera 151 and a detector 152. The monitoring camera 151 is disposed above the probe 133 and is configured to identify a position of the force-sensing deformable piece 130 with respect to the chip to be detected 120. The detector 152 is disposed in an oblique upward direction of the probe 133.

A laser beam emitted by the laser source 145 passes through the diaphragm assembly 144 to the reflecting prism 143. The laser beam is reflected by the reflecting prism 143 to a surface of the probe 133. Angle information of reflected light on the surface of the probe 133 is identified by the detector 152. When a deformation amount of the probe 133 on the chip to be detected 120 changes, an angle of the reflected light on the surface of the probe 133 changes, so as to detect a magnitude of a bonding force of the chip to be detected 120 on a substrate 121.

In a specific application, when using the optical lever detection device 100, a bonding force between the chip to be detected 120 and the substrate 121 is determined, the chip to be detected 120 is mounted on the sample conveying stage 110, and the sample conveying stage 110 is controlled to drive the chip to be detected 120 to move to the target detection position to enable the probe 133 to abut against the chip to be detected 120; the sample conveying stage 110 continues to drive the chip to be detected 120 to move toward the probe 133, so that the probe 133 generates a pressing force. The pressing force forces the force-sensing deformable piece 130 to generate the deformation amount. The probe 133 generates an angular deflection, and a reflection angle changes when the laser beam hits the surface of the probe 133. The angle information of reflected light on the surface of the probe 133 is identified and received by the detector 152. Then, the force-sensing deformable piece 130 converts the deformation amount into the angular deflection of the laser beam. The magnitude of the contact force of the force-sensing deformable piece 130 is calculated according to the deformation amount generated by the force-sensing deformable piece 130. By comparing the contact force of the force-sensing deformable piece 130 with a theoretical critical connection force between the chip to be detected 120 and the substrate 121 (the theoretical critical connection force refers to a maximum external force required to separate the chip to be detected 120 and the substrate 121 when the two achieve a complete welding area and optimal welding strength, and in the present disclosure, the external force is the pressing force between the chip to be detected 120 and the force-sensing deformable piece 130), it is determined whether a welding strength between electrodes of the chip to be detected 120 and a bonding pad on the substrate 121 is qualified. In this way, it reduces a probability of problems such as uneven brightness, color deviation, pixel failure, and inconsistent response time in a micro LED display, ensuring overall display quality and performance of the micro LED display, and improving a yield of the micro LED display.

It should be noted that the chip to be detected 120 in the present disclosure may be an individual chip or a chip array unit composed of chip units. When the chip to be detected 120 refers to the chip array unit, connection force detections need to be performed on the chip units in sequence during detection. In this case, a gap is defined between each two adjacent chip units, and a size of each gap should be sufficient to accommodate the probe 133, so that the probe 133 is able to abut against a side surface of a corresponding one of the chip units.

It is understood that the sample conveying stage 110 is specifically composed of an X-axis moving module, a Y-axis moving module, and a Z-axis moving module. The sample conveying stage 110 is configured to drive the substrate 121 to perform high-precision linear movement back and forth along an X-axis direction, a Y-axis direction, and a Z-axis direction respectively or synchronously, so as to ensure that the probe 133 is able to accurately move to each gap and effectively abut against the corresponding one of the chip units. The sample conveying stage 110 is configured to fix the substrate 121, thereby preventing the substrate 121 and the chip to be detected 120 mounted thereon from moving or rotating in the X-axis direction and the Y-axis direction due to an abutment force of the probe 133 during a detection process. Therefore, a detection result is not affected.

In one optional embodiment, a contact force between the probe 133 and the chip to be detected 120 is defined as F. A deflection angle between the cantilever 132 and the clamping portion 131 is defined as a. The deflection angle a is positively correlated with the contact force F. In one specific application, the sample conveying stage 110 continues to drive the chip to be detected 120 to move toward the probe 133, so that the pressing force is generated between the probe 133 and the chip to be detected. The pressing force forces the force-sensing deformable piece 130 to generate the deformation amount, so that the probe 133 generates the angular deflection. During this process, since the force-sensing deformable piece 130 comprises the clamping portion 131, the cantilever 132, and the probe 133, and the two ends of the cantilever 132 are respectively connected to the clamping portion 131 and the probe 133, and the probe 133 abuts against the chip to be detected 120, the pressing force generated between the probe 133 and the chip to be detected 120 forces the deflection angle a to form between the cantilever 132 and the clamping portion 131. That is, the contact force F between the probe 133 and the chip to be detected 120 is the pressing force, and the deflection angle a increases as the contact force F increases.

In one optional embodiment, a bonding force between the chip to be detected 120 and the substrate 121 is defined as f. A point where the laser beam hits the probe 133 is defined as a spot. One side of the probe 133 contacting the chip to be detected 120 is defined as a contact surface. A horizontal distance from the spot to the contact surface is defined as l. A horizontal distance from the contact surface to the cantilever 132 is defined as L. When 0 < F ≤ 1/2 f, l = 2/3 L. When 1/2 f < F ≤ f, l = 1/3 L. In one specific application, the bonding force between the chip to be detected 120 and the substrate 121 is defined as f. During the detection process, the sample conveying stage 110 slowly drives the chip to be detected 120 to move toward the probe 133. In practice, the connection strength between the chip to be detected 120 and the substrate 121 varies. In order to distinguish quality of the connection strength between the chip to be detected and the substrate 121 and improve detection accuracy, when 0<F≤1/2f, l=2/3L. That is, the contact force between the probe 133 and the chip to be detected 120 is relatively small. At this time, the deformation amount of the force-sensing deformable piece 130 is mainly concentrated between the clamping portion 131 and the cantilever 132. The laser beam should hit on one side of the probe 133 close to the cantilever 132. In this way, the connection strength between the chip to be detected 120 and the substrate 121 is effectively identified in batches during a process of continuously increasing the contact force F.

In one optional embodiment, the probe 133 is inclined downward and is connected to one end of the cantilever 132. A deflection angle between the cantilever 132 and the probe 133 is defined as b. When 1/2f<F≤f, the deflection angle b is positively correlated with the bonding force f. In one specific application, during a process where the contact force F gradually increases to approach f, a deflection deformation between the clamping portion 131 and the cantilever 132 is limited, and calculations when the contact force F is large are unable to be accurately identified. That is, as the contact force F continuously increases, the deflection deformation between the clamping portion 131 and the cantilever 132 remains substantially unchanged, resulting in inaccuracy when identifying a strong bonding force between the chip to be detected and the substrate 121. Therefore, when 1/2f<F≤f, l=1/3L, and the deflection angle between the cantilever 132 and the probe 133 is defined as b. The deflection angle b is positively correlated with the bonding force f. At this time, the deformation amount of the force-sensing deformable piece 130 is not only concentrated between the clamping portion 131 and the cantilever 132, but also concentrated between the cantilever 132 and the probe 133. The laser beam should hit on one side of the probe 133 away from the cantilever 132. In this way, the strong bonding force between the chip to be detected 120 and the substrate 121 is effectively identified.

In one optional embodiment, the support member 141 comprises a limiting groove 1411, a light guiding groove 1412, and a notch 1413. The limiting groove 1411 is disposed at one end of the support member 141. The light guiding groove 1412 communicates the laser source 145 with the limiting groove 1411. The reflecting prism 143 is slidable on the limiting groove 1411. The notch 1413 is disposed below and communicated with the limiting groove 1411. The clamp fixes the clamping portion 131 to one side of the limiting groove 1411. The notch 1413 directly faces the probe 133. The laser beam emitted by the laser source 145 respectively passes through the light guiding groove 1412, the limiting groove 1411, and the notch 1413 to the probe 133.

In one specific application, since the support member 141 comprises the limiting groove 1411, the light guiding groove 1412, and the notch 1413, the limiting groove 1411 is disposed at tone end of the support member 141, the light guiding groove 1412 communicates the laser source 145 with the limiting groove 1411, the reflecting prism 143 is slidable on the limiting groove 1411, the notch 1413 is disposed below and communicated with the limiting groove 1411; the clamp 142 fixes the clamping portion 131 to one side of the limiting groove 1411, and the notch 1413 directly faces the probe 133, so that by adjusting a position of the reflecting prism 143 in the limiting groove 1411, a position of the spot on the probe 133 changes accordingly, thereby changing the angle of the reflected light from the probe 133 according to the deformation of the cantilever 132 or the probe 133.

In one optional embodiment, the optical module 140 further comprises a first fastener 146 and a second fastener 147. The first fastener 146 is connected to the reflecting prism 143 in a direction parallel to the light guiding groove 1412, and the second fastener 147 abuts against the reflecting prism 143 in a direction perpendicular to the light guiding groove 1412, so as to adjust a position of the reflecting prism 143 with respect to the limiting groove 1411. In one specific application, the first fastener 146 is first rotated to make the reflecting prism 143 move forward or backward in the limiting groove 1411 in the direction parallel to the light guiding groove 1412, and then the second fastener 147 is rotated to fix the reflecting prism 143 on the limiting groove 1411, so as to adjust a position of the reflecting prism 143 with respect to the limiting groove 1411, thereby adjusting the position of the reflected light on the probe 133 after the laser beam passes through the reflecting prism 143.

In one optional embodiment, the diaphragm assembly 144 comprises a first diaphragm 1441 and a second diaphragm 1442. The first diaphragm 1441 and the second diaphragm 1442 are spaced apart on the light guiding groove 1412. In one specific application, the laser source 145 emits the laser beam, which is subjected to beam shrinking through the first diaphragm 1441 and the second diaphragm 1442 respectively. The first diaphragm 1441 and the second diaphragm 1442 are spaced apart on the light guiding groove 1412, and the laser beam is reflected by the reflecting prism 143 to a reflecting surface of the probe 133, and finally the reflected light from the probe 133 is reflected to the detector 152.

In one optional embodiment, the optical lever detection device 100 further comprises a digital terminal 160, and the digital terminal 160 is electrically connected to the monitoring camera 151 and the detector 152. In one specific application, the force-sensing deformable piece 130 converts the deformation amount into the angular displacement of the laser beam, and the monitoring camera 151 and the detector 152 transmit the angular displacement of the laser beam to the digital terminal 160. The digital terminal 160 converts the angular displacement of the laser beam into the electrical signal, so as to calculate the current bonding force of the chip. When the current bonding force reaches the magnitude of the theoretical critical connection force, the sample conveying stage 110 is controlled to stop moving.

### Embodiment 2

Differing from Embodiment 1, a protection subject of the embodiment is different.

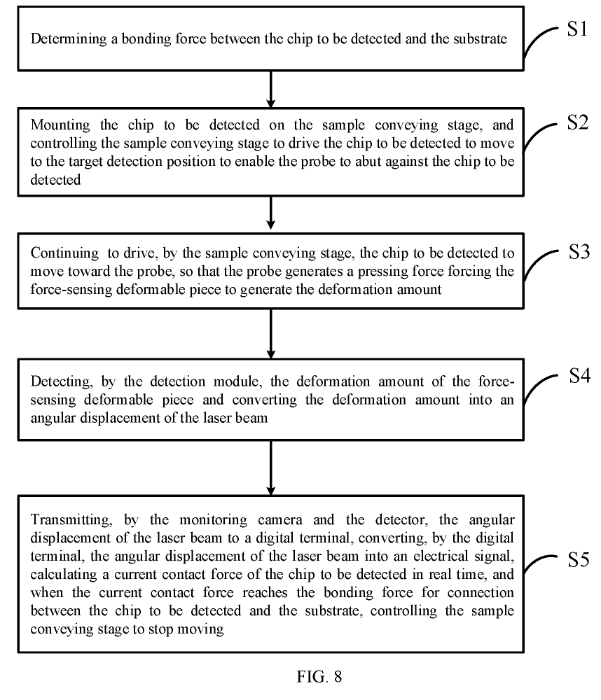

As shown in FIG. 8, the embodiment of the present disclosure provides an optical lever detection method for the micro LED chip. The optical lever detection method is applied to the optical lever detection device 100 described above and comprises steps S1-S5.

The step S1 comprises determining a bonding force between the chip to be detected 120 and the substrate 121.

The step S2 comprises mounting the chip to be detected 120 on the sample conveying stage 110, and controlling the sample conveying stage 110 to drive the chip to be detected 120 to move to the target detection position to enable the probe 133 to abut against the chip to be detected 120.

The step S3 comprises continuing to drive, by the sample conveying stage 110, the chip to be detected 120 to move toward the probe 133, so that the probe 133 generates a pressing force forcing the force-sensing deformable piece 130 to generate the deformation amount.

The step S4 comprises detecting, by the detection module 150, the deformation amount of the force-sensing deformable piece 130 and converting the deformation amount into an angular displacement of the laser beam.

The step S5 comprises transmitting, by the monitoring camera 151 and the detector 152, the angular displacement of the laser beam to a digital terminal 160, converting, by the digital terminal 160, the angular displacement of the laser beam into an electrical signal, calculating a current contact force of the chip to be detected 120 in real time, and when the current contact force reaches the bonding force for connection between the chip to be detected 120 and the substrate 121, controlling the sample conveying stage 110 to stop moving.

In one specific application, the magnitude of the bonding force between the chip to be detected 120 and the substrate 121 is first determined. The chip to be detected 120 is mounted on the sample conveying stage 110, and the sample conveying stage 110 is controlled to drive the chip to be detected 120 to move to the target detection position to enable the chip to be detected 120 to abut against the probe 133. The sample conveying stage 110 continues to drive the chip to be detected 120 to move toward the probe 133, so that the pressing force is generated between the chip to be detected 120 and the probe 133. The pressing force forces the force-sensing deformable piece 130 to generate the deformation amount. The force-sensing deformable piece 130 converts the deformation amount into the angular displacement of the laser beam, and the monitoring camera 151 and the detector 152 transmit the angular displacement of the laser beam to the digital terminal 160. The digital terminal 160 converts the angular displacement of the laser beam into the electrical signal, so as to calculate the current bonding force. When the magnitude of the current bonding force reaches the magnitude of the theoretical critical connection force, the sample conveying stage 110 is controlled to stop moving. By comparing the contact force of the force-sensing deformable piece 130 with the theoretical critical connection force between the chip to be detected 120 and the substrate 121 (the theoretical critical connection force refers to the maximum external force required to separate the chip to be detected 120 and the substrate 121 when the two achieve a complete welding area and optimal welding strength, and in the present disclosure, the external force is the pressing force between the chip to be detected 120 and the force-sensing deformable piece 130), it is determined whether the welding strength between electrodes of the chip to be detected 120 and the bonding pad on the substrate 121 is qualified. In this way, it reduces the probability of problems such as uneven brightness, color deviation, pixel failure, and inconsistent response time in the micro LED display, ensuring the overall display quality and performance of the micro LED display, and improving the yield of the micro LED display.

In one optional embodiment, before the step of when the current contact force reaches the bonding force for the connection between the chip to be detected 120 and the substrate 121, controlling the sample conveying stage 110 to stop moving, the optical lever detection method further comprises: controlling the reflecting prism 143 to move away from the probe 133 when the bonding force is much greater than the contact force; and controlling the reflecting prism 143 to move toward the probe 133 when the bonding force is close to the contact force.

In one specific application, when the bonding force is much greater than the contact force, the deformation amount of the force-sensing deformable piece 130 is mainly concentrated between the clamping portion 131 and the cantilever 132; and the reflecting prism 143 is adjusted to move in the direction away from the probe 133, so that the laser beam falls on the one side of the probe 133 close to the cantilever 132. When the bonding force is close to the contact force, the deformation amount of the force-sensing deformable piece 130 is not only concentrated between the clamping portion 131 and the cantilever 132, but also concentrated between the cantilever 132 and the probe 133; and the reflecting prism 143 is adjusted to move toward the probe 133, so that the laser beam falls on the one side of the probe 133 away from the cantilever 132.

The above-mentioned embodiments only express several embodiments of the present disclosure, and the description thereof is relatively specific and detailed, but should not be construed as a limitation on the scope of the present disclosure. It should be noted that for those of ordinary skill in the art, several modifications and improvements can be made without departing from the concept of the present disclosure, and these modifications and improvements should fall within the protection scope of the present disclosure.

What is claimed is:

1. An optical lever detection device for a micro light emitting diode (LED) chip, comprising:
a sample conveying stage;
a force-sensing deformable piece;
an optical module; and
a detection module;
wherein the sample conveying stage is configured to carry a chip to be detected and convey the chip to be detected to a target detection position;
wherein the force-sensing deformable piece comprises a clamping portion, a cantilever, and a probe, two ends of the cantilever are respectively connected to the clamping portion and the probe, and the probe abuts against the chip to be detected;
wherein the optical module comprises a support member, a clamp, a reflecting prism, a diaphragm assembly, and a laser source, wherein one end of the clamp connected to the support member is configured to connect the clamping portion, the reflecting prism is slidable on the support member and is disposed above the clamping portion, the laser source is disposed on one side of the support member away from the reflecting prism, and the diaphragm assembly is disposed between the laser source and the reflecting prism;
wherein the detection module comprises a monitoring camera and a detector, the monitoring camera is disposed above the probe and is configured to identify a position of the force-sensing deformable piece with respect to the chip to be detected, and the detector is disposed in an oblique upward direction of the probe;
wherein a laser beam emitted by the laser source passes through the diaphragm assembly to the reflecting prism, the laser beam is reflected by the reflecting prism to a surface of the probe, and angle information of reflected light on the surface of the probe is identified by the detector;
wherein when a deformation amount of the probe on the chip to be detected changes, an angle of the reflected light on the surface of the probe changes, so as to detect a magnitude of a bonding force of the chip to be detected on a substrate.

2. The optical lever detection device according to claim 1, wherein a contact force between the probe and the chip to be detected is defined as F, a deflection angle between the cantilever and the clamping portion is defined as a, and the deflection angle a is positively correlated with the contact force F.

3. The optical lever detection device according to claim 2, wherein a bonding force between the chip to be detected and the substrate is defined as f, a point where the laser beam hits the probe is defined as a spot, one side of the probe contacting the chip to be detected is defined as a contact surface, a horizontal distance from the spot to the contact surface is defined as l, and a horizontal distance from the contact surface to the cantilever is defined as L;
wherein when 0 < F ≤ 1/2 f, l = 2/3 L; and when 1/2 f < F ≤ f, l = 1/3 L.

4. The optical lever detection device according to claim 3, wherein the probe is inclined downward and is connected to one end of the cantilever, a deflection angle between the cantilever and the probe is defined as b, and when 1/2f<F≤f, the deflection angle b is positively correlated with the bonding force f.

5. The optical lever detection device according to claim 1, wherein the support member comprises a limiting groove, a light guiding groove, and a notch;
wherein the limiting groove is disposed at one end of the support member, the light guiding groove communicates the laser source with the limiting groove, the reflecting prism is slidable on the limiting groove, the notch is disposed below and communicated with the limiting groove, the clamp fixes the clamping portion to one side of the limiting groove, and the notch directly faces the probe;
wherein the laser beam emitted by the laser source respectively passes through the light guiding groove, the limiting groove, and the notch to the probe.

6. The optical lever detection device according to claim 5, wherein the optical module further comprises a first fastener and a second fastener, the first fastener is connected to the reflecting prism in a direction parallel to the light guiding groove, and the second fastener abuts against the reflecting prism in a direction perpendicular to the light guiding groove, so as to adjust a position of the reflecting prism with respect to the limiting groove.

7. The optical lever detection device according to claim 5, wherein the diaphragm assembly comprises a first diaphragm and a second diaphragm, and the first diaphragm and the second diaphragm are spaced apart on the light guiding groove.

8. The optical lever detection device according to claim 1, wherein the optical lever detection device further comprises a digital terminal, and the digital terminal is electrically connected to the monitoring camera and the detector.

9. An optical lever detection method for a micro LED chip, applied to the optical lever detection device according to claim 1, comprising steps:
S1: determining a bonding force between the chip to be detected and the substrate;
S2: mounting the chip to be detected on the sample conveying stage, and controlling the sample conveying stage to drive the chip to be detected to move to the target detection position to enable the probe to abut against the chip to be detected;
S3: continuing to drive, by the sample conveying stage, the chip to be detected to move toward the probe, so that the probe generates a pressing force forcing the force-sensing deformable piece to generate the deformation amount;
S4: detecting, by the detection module, the deformation amount of the force-sensing deformable piece and converting the deformation amount into an angular displacement of the laser beam; and
S5: transmitting, by the monitoring camera and the detector, the angular displacement of the laser beam to a digital terminal, converting, by the digital terminal, the angular displacement of the laser beam into an electrical signal, calculating a current contact force of the chip to be detected in real time, and when the current contact force reaches the bonding force for connection between the chip to be detected and the substrate, controlling the sample conveying stage to stop moving.

10. The optical lever detection method according to claim 9, wherein before the step of when the current contact force reaches the bonding force for connection between the chip to be detected and the substrate, controlling the sample conveying stage to stop moving, the optical lever detection method further comprises:
controlling the reflecting prism to move away from the probe when the bonding force is much greater than the contact force; and
controlling the reflecting prism to move toward the probe when the bonding force is close to the contact force.
